(19) United States
(12) Patent Application Publication
(10) Pub. No.: US 2024/0083655 A1
(43) Pub. Date: Mar. 14, 2024

(54) EXPANDABLE POLYLACTIC ACID-BASED THERMAL AND PROTECTIVE PACKAGING HAVING ADVANCED LIVING HINGES AND METHODS THEREOF

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/476,956

(22) Filed: Sep. 28, 2023

Related U.S. Application Data
(63) Continuation-in-part of application No. 18/356,611, filed on Jul. 21, 2023.
(60) Provisional application No. 63/369,005, filed on Jul. 21, 2022.

(51) Int. Cl. B65D 81/05; B65D 81/02; B65D 81/107

(52) U.S. Cl. CPC B65D 81/054; B65D 65/44; B65D 81/022; B65D 81/107; B29C 44/06; B65D 2581/055

(57) ABSTRACT

Molded foam articles are provided. The molded foam articles have at least one surface having at least a portion that has been skin-formed for forming a skin-formed living hinge for enabling a robust living hinge capable of hundreds of open/close cycles at angles of up to 270°.

### CROSS-REFERENCE TO RELATED APPLICATIONS

This application is a continuation-in-part of U.S. patent application Ser. No. 18/356,611, filed Jul. 21, 2023, which claims priority to U.S. Provisional Patent Application No. 63/369,005, filed Jul. 21, 2022, both of which are incorporated herein by reference.

### FIELD OF THE DISCLOSURE

This disclosure relates generally to molded foam articles and, in particular, relates to molded foam articles formed from polylactic acid having living hinges formed from skin-formed surfaces.

### BACKGROUND

Molded foam articles are used in a variety of diverse industries including thermal insulation and protective packaging, construction, infrastructure support, foodservice, and consumer products such as surfboards. Molded foam articles are commonly produced from expandable polystyrene (EPS), which has a well-known manufacturing process. However, EPS-based foam articles suffer from a variety of drawbacks that require compensating the properties of the EPS-based foam articles so that they may successfully be used for their desired purpose.

Consumer-facing foam articles such as insulated shippers are commonly used for shipping meal kits, confectionary products, cakes, other perishable goods, and pharmaceutical items such as vaccines. Other thermal shippers lack appreciable resistance to water transfer, requiring a hydrophobic barrier which requires more resources than recovered by recycling.

Furthermore, shipping appliances and other heavy goods requires protective foam having higher compressive and flexural properties. EPS-based packaging must be at least 0.5 inches thick and must be produced at super high density to achieve the higher compressive and flexural properties. This results in higher energy and material use for production. In other words, EPS-based packaging uses higher density foam to achieve higher compressive strength, but at the cost of increased material content. It is desirable to keep material content low while increasing compressive strength, which is not possible with EPS-based packaging.

The impact and vibration protection provided by protective packaging varies by direction. Conventional EPS-based packaging has mechanical properties in the x-y plane as compared to the x-z or y-z plane that is within 20% for larger and heavier parts and within 10% for smaller and lighter parts. This variation is a side effect of the EPS production method. However, it is desirable to have a low weight foam product engineered with mechanical properties in different directions that vary by amounts greater than 20% to provide sufficient protection to heavy parts without increasing the weight of the protective packaging.

Many embodiments of protective packaging utilize an insulating material in combination with an additional supporting structure, such as corrugated cardboard. These articles often pack loose insulation into film or paper before lining the inside of a corrugated cardboard box with these “envelopes” of insulation. Prior attempts to omit corrugated cardboard supplement the article with adhesive, film, tape, glue, or some other means of joining separate pieces of insulating material into a single unit. In any event, prior solutions require the end-user to separate insulating material from paper, film, and/or cardboard in order to recycle or compost any material.

One means by which corrugated cardboard can be omitted from packaging is forming the product packaging out of molded bead foam having living hinges. Living hinges enable the folding and unfolding of the packaging so that the boxes can be shipped in a flat configuration, which improves costs associated with transportation. Furthermore, a “lid” joined to the package via a living hinge is easily opened and closed by a consumer.

One prior attempt to formulate a living hinge includes forming the living hinge in a monolithic bead foam article using an anvil, such as the method depicted in FIG. 11. This living hinge is formed by compressing the webbing that bridges two foam panels using specially designed equipment. However, in addition to the need for special equipment, this solution densifies the foam beads in the webbing to a density between 5 and 10 times greater than the foam article itself, so the webbing requires a substantial amount of material relative to the volume of the hinge itself. Furthermore, this method is best practiced in a symmetric mold with the anvil in the middle to ensure a symmetrical living hinge is formed. Further still, this method requires a preexisting groove in the bead foam article having a shape specifically configured to be densified by the shaped anvil; no other shapes would work without a modified anvil.

Accordingly, improved molded foam articles with improved living hinges are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A is a cross-sectional view of one embodiment of a foam structure having two skin-formed living hinges in accordance with the present disclosure.

FIG. 1B is a perspective view of one embodiment of a foam structure having a skin-formed living hinge in accordance with the present disclosure.

FIG. 1C is a cross-sectional view of one embodiment of a foam structure having a skin-formed living hinge in an open configuration in accordance with the present disclosure.

FIG. 1D is a cross-sectional view of one embodiment of a foam structure having a skin-formed living hinge in a closed configuration in accordance with the present disclosure.

FIG. 2 is a perspective view of another embodiment of a foam structure in having a skin-formed living hinge accordance with the present disclosure.

FIG. 3 is a perspective view of one embodiment of a 3-panel system having skin-formed living hinges in accordance with the present disclosure.

FIG. 4A is a perspective view of one embodiment of a 2-panel system having a skin-formed living hinge in accordance with the present disclosure.

FIG. 4B is a perspective view of the embodiment of the 2-panel system shown in FIG. 4A after it has been folded into an edge protector in accordance with the present disclosure.

FIG. 5 is a cross-sectional view of one embodiment of a foam structure having a skin-formed living hinge in an open configuration in accordance with the present disclosure.

FIGS. 6A-6C are cross-sectional views of one embodiment of a foam structure having a skin-formed living hinge in accordance with the present disclosure.

FIGS. 7A-7B depict one embodiment of a foam structure having a skin-formed living hinge in accordance with the present disclosure.

FIG. 8 depicts one embodiment of a foam structure having a skin-formed living hinge in accordance with the present disclosure.

FIG. 9 is a block flow diagram depicting one embodiment of a method for making a foam structure in accordance with the present disclosure.

FIG. 10 is a schematic illustrating one embodiment of a step in a method for making a foam structure in accordance with the present disclosure.

FIG. 11 is an illustration of a living hinge made by a fabrication method in the prior art.

### DETAILED DESCRIPTION

Molded foam articles are provided herein including molded foam articles having one or more skin-formed living hinges. The molded foam articles with living hinges, and methods of making the living hinges, advantageously reduces the number of component parts, reduces assembly time, simplifies assembly, improves thermal protection, and improves impact protection of conventional living hinges. Furthermore, it has been unexpectedly discovered that forming and/or reinforcing the living hinge by forming a skin on one or more surfaces of one or more foam articles results in a living hinge that may be formed in seconds, requiring a minimal amount of material or densification and without any additional material such as films or tapes, and having a high tensile strength capable of withstanding over 100 rotation cycles up to 270°.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

Molded Bead Foam Articles with Skin-Formed Living Hinges

Molded foam articles formed from polylactic acid (PLA) having a skin-formed living hinge are disclosed herein. As used herein, a “molded foam article” refers to an article formed from a polymeric foam that has gone through an expansion and bead molding or fusing process. As used herein, “PLA-based article” refers to a foam article comprising polylactic acid. The article may be in the form of a two-dimensional panel or a three-dimensional structure such as a box.

As used herein, the term “living hinge” refers to a piece of material, e.g. polymer foam, joining two components that are formed of the same material together, e.g. component foam articles. That is, the term “living hinge” refers to a flexible, bendable region of a material connecting at least two relatively inflexible regions of the material. The flexible and inflexible regions may be integrally connected, e.g., as a part a single, monolithic structure. The flexible and inflexible regions may be connected as a result of the skin-forming process. Before reinforcing the bead foam to form the living hinge, the inflexible regions may be connected by a region that is sometimes called “webbing” that is subsequently reinforced to form the living hinge. The webbing may have a thickness of up to about 7 foam particles with typical thickness of 2-4 beads. In this way, the two component foam articles may be folded against each other along the living hinge, without requiring the addition of a separate piece of material and without charging the end-user with separation or disassembly of the components from the living hinge. For example, the living hinge may be defined by a channel that is formed between two adjacent component foam articles and then subsequently skin-formed as described herein. As another example, the living hinge may be formed by positioning two component foam articles next to one another and then skin-formed to join the articles.

As used herein, a “skin-formed” surface or portion of a surface is one that has gone through a “skin-forming” process by which the portion of the surface is exposed to sufficient heat, optionally with the application of pressure on the order of less than 30 psi, such as between 5-10 psi, so that the molded beads at the surface of the molded bead foam article experience a heightened degree of fusion compared to the beads in the interior of the molded bead foam article. Skin-forming results in a smoother surface compared to a surface that has not been skin-formed, and the skin-formed surface imparts heightened compressive strength, tensile strength, and flexural strength to the molded bead foam article compared to a molded bead foam article without a skin-formed surface. It has further been unexpectedly discovered that skin-forming can be performed on curved or irregular surfaces, enabling these mechanical and thermal enhancements on surfaces that were previously incapable of enhancements, even by conventional means.

In some embodiments, the thickness of the skin-formed portion is between 5 mil and 30 mil. The skin-forming process primarily affects the foam beads on the surface of the foam article, with some skin-forming effects passing to those beads beneath the outermost layer.

The living hinges of the present disclosure may take the form of a grooved channel between two articles joined by webbing that is enhanced by a skin-forming process, or it may take the form of a skin-formed surface that joins two articles that were otherwise completely separated. Both embodiments of the living hinge are contemplated by the phrase “skin-formed living hinge.”

In some embodiments, the molded bead foam article having a living hinge includes at least two component foam articles joined by the living hinge. As used herein, a “component foam article” refers to a foam article that is joined to another component foam article by a living hinge. In embodiments in which the living hinge is initially formed as part of the molding process, the “component foam articles” may be joined by webbing and may not be discrete, separate articles. In embodiments in which the skin-forming process forms the living hinge in the first instance, the component foam articles are discrete, separate articles. Each component foam article has a surface or edge, referred to herein as an “interface,” proximal to the other component foam article, at least a portion of which has been skin-formed to form the living hinge. In some embodiments, the interface takes the form of a grooved channel between articles joined by webbing that is initially formed as part of the molding process. In other embodiments, the interface simply refers to the space between two discrete, separate component foam articles.

In some embodiments, the molded bead foam articles include a plurality of component foam articles having edges. Each of the component foam articles is formed out of polymer foam particles comprising polylactic acid. At least two of the plurality of component foam articles are disposed next to one another and are integrally connected along one of the edges of each of the at least two component foam articles by a skin-formed living hinge. The living hinge allows the adjacent component foam articles to fold towards one another along the living hinge. As used herein, a “component foam article” refers to a monolithic article having a continuous composition throughout that is intended to be joined or combined with one or more other component foam articles to form the bead foam article of the present disclosure. In some embodiments, a single component foam article is in the form of a “panel,” characterized by a substantially planar appearance. In some embodiments, a single component foam article corresponds to one side of a shipper, box, or other container. The component foam article could be any shape, such as a square, rectangle, or other polygon. The component foam article could have a thickness of from about 0.25 inches (6.4 mm) to about 4 inches (100 mm), for example about 0.25 inches (6.4 mm), about 0.375 inches (9.52 mm), about 0.5 inches (13 mm), about 0.75 inches (19 mm), or about 1 inch (25 mm). The thickness could be 1.25 inches (31.8 mm), 1.5 inches (38 mm), 2 inches (50 mm), 3 inches (80 mm), 6 inches (150 mm), or any thickness in between depending on the desired thermal and mechanical properties. The component foam article may have a side-length of from about 1 inch (25 mm) to about 48 inches (1220 mm) or greater, for example about 1 inch (25 mm), about 2 inches (50 mm), about 6 inches (150 mm), about 12 inches (305 mm), about 24 inches (609 mm), about 36 inches (914 mm), about 48 inches (1220 mm), greater than 48 inches, or any side-length in between depending on the desired size, thermal properties, and mechanical properties of the insulating structure.

As used herein, the “thickness” of a component foam article refers to the depth of the component foam article measured from approximately the center of the component foam article. In other words, a component foam article having a beveled edge or a component foam article connected to another component foam article by a living hinge is described has having the same “thickness” as a component foam article with rectilinear edges or a component foam article without a living hinge, although the depth of the component foam article changes at the edges and/or at the living hinge by virtue of being beveled and shaped.

The component foam articles may be used in plurality, where two or more component foam articles constitute the molded bead foam article and are used as a self-supporting container or to enhance the thermal properties of another container, box, shipper, or other structure. Thus, any plurality of component foam articles may form the molded bead foam article and constitute a stand-alone container, box, or shipper. For example, a molded bead foam article composed of six component foam articles joined by living hinges would form a standard 6-sided box and may be used without a housing or outer box.

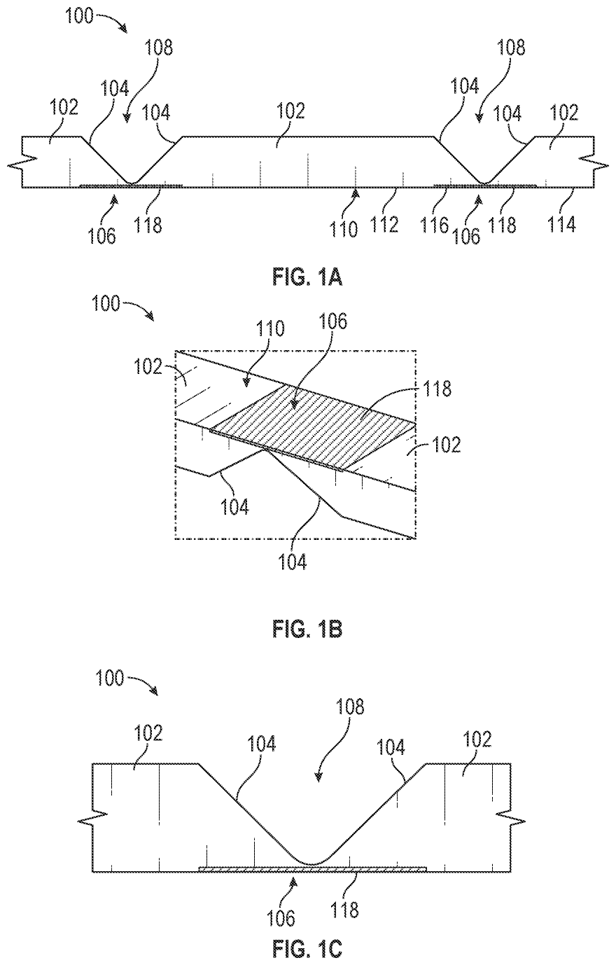

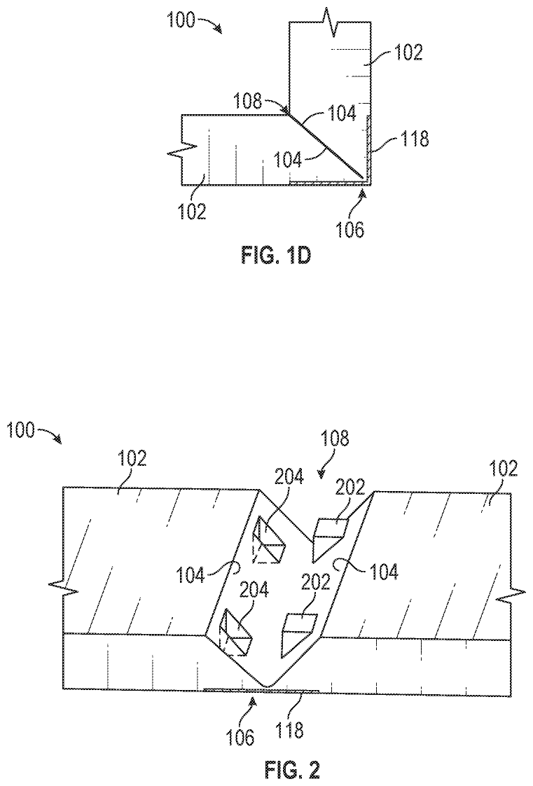

In some embodiments, the component foam articles are joined by webbing that is initially formed by a molding process and includes a grooved channel between the component foam articles, such as the one depicted in FIGS. 1A-1D. In other embodiments, the living hinge is formed in the first instance by the skin-forming process, as depicted in FIGS. 6A-6C. In embodiments in which the component foam articles are joined by webbing with a grooved channel, skin-forming the living hinge provides the necessary enhancement in bead foam strength to enable folding of the component foam articles without the need for special equipment and without requiring additional foam beads in the living hinge. In embodiments in which two separate component foam articles are disposed proximal to one another and then skin-formed to form the living hinge, the skin-forming process joins each component foam article to form the molded bead foam article having a living hinge. The skin-formed living hinge connects the two component foam articles such that the component foam article may fold together and seal in thermal energy, i.e., form a “seal.”

As used herein, the term “seal” means a juncture formed by two or more surfaces of one or more objects substantially coming into contact with each other in a manner that reduces or prevents the transfer of thermal energy and airflow through, around, or in connection with the seal.

In some embodiments, the component foam articles are rigid. As used herein, the term “rigid” means having a modulus of elasticity per ASTM C203 greater than 1 MPa. A rigid object therefore tends to break rather than deform. Note that a rigid object must have a high flex strength, which is the stress at failure in a bending test so it does not break during loading or impact.

In some embodiments, the PLA-based foam particles are compostable and/or biodegradable. Foam structures comprising biodegradable polymer foam particles may degrade by industrial compost facility in about 7 to about 42 days, such as within about 7 to about 21 days. The term “compostable” is used to refer to materials that meet or exceed the relevant degradation standards in commercial composting facilities, such as the standards enumerated in ASTM D5338, ASTM D6400, and/or ISO 20200. For example, the compostable articles described herein degrade per the criteria set forth in ASTM D5338, ASTM D6400, and/or ISO 20200. That is, the compostable articles described herein degrade or be digested by microbes in a controlled compost study within 180 days, 90 days, or shorter. In certain embodiments, the compostable articles described herein are compostable in an industrial compost in about 42 days or shorter.

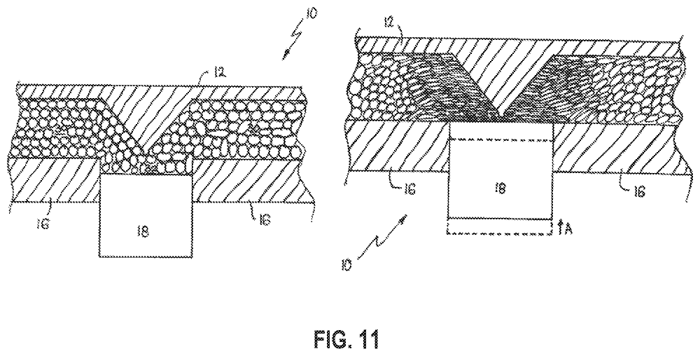

In some embodiments, the living hinge includes webbing formed by a molding process that joins the component foam articles, without any post-conditioning process. As used herein, “molding” the polymer foam particles refers to a molding process in which polymer foam particles are injected into a mold where they are compressed in the presence of steam to collapse the polymer foam particles and form a monolithic foam article. The formation of a living hinge using conventional molding methods, such as the one depicted in FIG. 11, has limitations on the thickness of the webbing, i.e., the webbing must have a thickness of at least 4 polymer foam particles, but likely a thickness of between approximately 8 to 12 polymer foam particles to enable a robust living hinge after compressing the webbing with the anvil. However, the skin-formed living hinges of the present disclosure, if initially present in the form of webbing, may have a thickness of 2 to 4 polymer foam particles. In other embodiments, the component foam articles are formed by a molding process but are otherwise discrete and separate before being joined by a skin-formed living hinge, i.e., they may not be joined by webbing.

In some embodiments, the interfacing edges of the at least two component foam articles are beveled. As used herein, the term “beveled” means sloped or angled relative to a right-angle. More specifically, a “beveled edge” means an edge that is sloped or angled relative to an edge consisting of right-angles.

In some embodiments, the interfacing edges of the at least two component foam articles include edge features, such as mechanical locking tabs and mechanical locking slots, wherein the tabs and the slots are configured to interlock to secure two or more component foam articles to one another and/or guide or align two or more component foam articles joined by a living hinge when they are folded together. In some embodiments, the interfacing edges of at least two component foam articles have mechanical locking tabs and mechanical locking slots to facilitate a friction fit or compression fit interlock. Such locking, or interlocking, features can facilitate securing the living hinge in a closed configuration, which, for example, may be useful in the process of assembling component foam articles into a container.

In embodiments, the at least two component foam articles connected by a skin-formed living hinge share a common surface. A first surface of a first component foam article joins a second surface of the adjacent component foam article. The first surface and the second surface together form the living hinge surface, i.e., the surface that is deformed and under the most stress when the living hinge is actuated. The common surface is thus continuous across the first component foam article, the living hinge, and the second component foam article. The living hinge surface is skin-formed to improve the properties of the living hinge, as described herein. Therefore, in some embodiments, a first surface of a first component article is proximal to a second surface of a second component foam article, and the first surface and the second surface have been skin-formed.

In some embodiments, a sufficient number of component foam articles are joined by a sufficient number of skin-formed living hinges so that a stand-alone container may be formed. For example, a six-sided box may be formed from six component foam articles and at least five skin-formed living hinges, i.e., enough to join the six component foam articles together. In other embodiments, the molded bead foam article may be formed out of a select number of component foam articles with sufficient number of skin-formed living hinges and may be used as, for example, an edge protector.

In some embodiments, the entire interface between component foam articles is skin-formed so that a living hinge is formed spanning the entire length of the component foam articles. In some embodiments, one or more discrete portions of the interface between component foam articles is skin-formed, such as two portions, three portions, or more, so that one or more smaller living hinges are formed joining the component foam articles. In other embodiments, the molded bead foam article may be used in conjunction with an outer box, such as a corrugated cardboard box, to provide improved thermal retention, thermal exclusion, and/or prevention or reduction of thermal energy transfer to or from a container that would otherwise lack such capabilities.

In some embodiments, the skin-formed living hinge has a greater tensile strength than a living hinge formed in a conventional EPS-based foam article having the same density. Living hinges formed as depicted in FIG. 11 achieve suitable structural integrity substantially increasing the density of the foam beads using a compression process enabled by special equipment. The skin-forming process described herein may be achieved with simple equipment through the application of heat and pressure between about 5 psi and 30 psi.

Without intending to be bound by any particular theory, conventional EPS molding processes produce an EPS-based molded foam article that is incapable of being skin-formed because of the presence of pentane blowing agent within the EPS beads. Performing a skin-forming process on freshly molded or, in some cases, up to 72-hour aged EPS-based molded foam articles results in either overexpansion of the beads that form the molded article surface, or a contraction of cells that subsequently forms a weak crystalline skin, deteriorating the mechanical properties of the article. In order to form a living hinge capable of withstanding repeated fold and unfold cycles, a particular compressive resistance, tensile strength, or flexural strength is desired in an EPS-based molded foam article, so the density must be increased. A high compressive strength and modulus in an EPS-based molded foam article is only achievable when the density of the hinge, after compression, is between 200% and 400% greater than the surrounding, uncompressed bead foam. In contrast, the skin-formed living hinge of the present disclosure has the same compressive strength and modulus as densified EPS living hinges at a density of only 2% to 15% greater than the surrounding foam. In some embodiments, the skin-formed living hinge has a density of between about 1.0 pcf and about 6.0 pcf.

It has been unexpectedly discovered that forming the living hinge via skin-forming further enables reinforcement of the PLA molded bead foam article at the corners formed by the hinge. For example, skin-forming only an edge, a corner, or multiple edges and/or corners improves the compressive resistance of the edges and/or corners such that the molded bead foam article is capable of passing a drop test. Thus, skin-formed living hinges advantageously increases the ability for the molded bead foam article, which may be in the form of an insulated shipper, to pass a drop test and/or better protect the contents of the article. Conventional EPS-based foam articles require an increase in density in order to pass a drop test, including any living hinges that may be present in the EPS-based foam articles.

In some embodiments, the skin-formed living hinge is leak-proof. Molded foam articles are often used as coolers, and shipping certain commodities such as seafood is ideally performed with a shipper that will not secrete any liquids from within the shipper. It has been surprisingly discovered that forming a skin-formed living hinge can increase the resistance to water elution through the skin-formed living hinge. In some embodiments, the inside surface of the molded foam article may be skin-formed to avoid secretion of liquid. In some embodiments, the outside surface may be skin-formed to avoid secretion of liquid. In some embodiments, both the inside surface and the outside surface may be skin-formed to avoid secretion of liquid.

In some embodiments, the molded bead foam article with at least one skin-formed living hinge is capable of being used as a shipper with no additional material. In some embodiments, the PLA-based molded bead foam article includes identifying information printed directly on the at least one skin-formed portion of the at least one surface. As described previously, the skin-forming process produces a smooth surface, and it has been unexpectedly discovered that the skin-formed portion is suitable for direct printing of identifying information, eliminating the need for labels.

In some embodiments, the identifying information is printed with ink comprising ethanol, methyl ethyl ketone (MEK), water, or a combination thereof, thereby preserving the recyclability of the PLA-based molded article.

In some embodiments, the molded bead foam article has an anisotropic compressive modulus, an anisotropic flexural modulus, or both. It has been unexpectedly discovered that by forming a skin-formed living hinge, the mechanical properties of the bead foam article can change anisotropically. The use of such living hinges can provide differentiated protection when exposed to horizontal and vertical vibration simultaneously. For example, a tall and heavy object can use protective edges created using skin-formed living hinges which resist compression and potentially damaging oscillations in vertical direction while providing simple contact protection in horizontal direction. In contrast, a high density EPS-based foam article designed for compression in, for example, the vertical direction would have inferior protection in horizontal direction. The anisotropic nature of skin-formed living hinges advantageously enables foam that is easier to manually break or fracture in one direction than another. Protective packaging utilizing skin-formed living hinges with anisotropic mechanical properties can therefore break into smaller pieces when removing from the box or enable the consumer to break the protective packaging into smaller pieces that more easily fit in a waste receptacle. Furthermore, configuring the foam to have designed breakage minimizes the production of stray beads upon breakage.

In some embodiments, the molded bead foam article is in the form of a protective-guard, such as an edge-guard or corner-guard, having a plurality of sides joined by skin-formed living hinges. It has been unexpectedly discovered that by forming a box having select sides joined by a skin-formed living hinge, the mechanical protection of the protective guard may be tailored for the application or goods stored/shipped inside. Previous attempts to produce packaging with customized mechanical properties include the use of additional foam pieces, sometimes formed from a different material or having a different density which would require a secondary molding process and/or apparatus. Skin-forming the living hinge may be performed swiftly and without special equipment, thereby enabling the production of custom packaging at minimal material and manufacturing cost.

In some embodiments, the molded bead foam article is in the form of a fold-flat shipper configured to fold into a container for shipping commodities. As used herein, a “fold-flat shipper” refers to a shipper that may be unfolded into a flat configuration. For example, a shipper in the form of a 6-sided box may be unfolded so that each of the 6 sides are flat, and each of the 6 sides is connected to at least one other side. It has been unexpectedly discovered that skin-formed living hinges permits formation of a self-standing box. The properties of a box made with fold flat “C”-shaped component foam articles or individual component foam articles is comparable to a molded box with similar dimensions. Skin-forming the living hinges increases tensile and compression properties. The fold-flat shipper occupies around 50% less volume during shipment and storage.

FIG. 1A shows a foam structure 100 including a plurality of component foam articles 102 having edges 104. The component foam articles are connected by webbing 106 defined by channels 108. A common surface 110 joins a surface 112 of one component foam article 102, a surface 114 of an adjacent component foam article 102, and a webbing surface 116 of webbing 106. In this way, the common surface 110 is continuous across the adjacent component foam articles 102 and the webbing 106. The webbing surface 116 is skin-formed to form a skin-formed portion 118, thereby forming the skin-formed living hinge. The webbing 106 is generally too weak to operate as a living hinge without subsequent modification. As described previously, prior art webbing is compressed to enable use as a living hinge, as shown in FIG. 11. As described herein, the component foam articles joined by webbing are skin-formed to enable use as a living hinge. In some instances, the foam structure has two component foam articles joined at interfacing edges by a skin-formed living hinge. In other instances, the foam structure has more than two component foam articles, such as three, four, five, or more component foam articles, where each pair of interfacing edges is joined by a skin-formed living hinge. The component foam articles may have a square shape having four edges of equal length, a rectangular shape having two pairs of edges of varying lengths, or another shape having a corresponding number of edges with suitable lengths. In some instances, the channel has a “V” shape in cross-section. In other instances, the channel has a rectilinear or other suitable shape. In other instances, the edges of the channel have curved, ridged, or undulating surfaces.

As used herein, a channel having a “‘V’ shape” refers generally to two component foam articles having respective beveled or angled edges that are connected by a skin-formed living hinge. The “V” shape may resemble a “V,” wherein the beveled edges of connected component foam articles meet at a sharp, angled corner. Alternatively, the “V” shape may have a curved profile at the point where the connected component foam articles meet resembling a “V” with a rounded point instead of a sharp corner (e.g., a “U” shape). Thus, the use of “V” throughout is in the interest of brevity, and any suitable geometry of the two component foam articles connected by a living hinge may be used. Moreover, as explained above, the channel may have a rectilinear or other suitable shape.

The interfacing edges of least two component foam articles may be configured to be brought into contact in a manner so as to form a thermal seal between those component foam articles, i.e., to prevent or reduce the thermal energy transfer between an internal volume defined by the component foam articles and an external volume outside of the volume enclosed by the component foam articles 102. The length of one edge may or may not be the same length as an interfacing edge so that a seal is formed between adjacent edges. The shape of one edge may correspond to the shape of an interfacing edge so that a seal is formed between adjacent edges. Various configurations of such corresponding edges are described below; however, any suitable mechanical edge connection that achieves the desired thermal seal between adjacent component foam articles may be utilized. The shape of all edges of a component foam article may be the same, or some edges may have one shape, e.g., beveled, while other edges have another shape, e.g., rectilinear.

FIG. 1B shows a foam structure 100 including two component foam articles 102 having edges 104 and joined by webbing 106 defined by channel 108 and having a skin-formed portion 118 that forms the skin-formed living hinge, such as may be used to form an insulating insert or partial insulating container, or which may be combined with additional component foam articles to form a container, as described herein.

FIG. 1C shows a foam structure 100 including two component foam articles 102 having edges 104 and joined by webbing 106 defined by channel 108 and having a skin-formed portion 118 that forms the skin-formed living hinge. FIG. 1C depicts foam structure 100 in an unfolded state, or open configuration. FIG. 1D depicts the foam structure 100 of FIG. 1C in a folded state, or closed configuration. In some instances, the edges of the component foam articles are shaped at an angle, such as through beveling, chamfering, scouring, or other process to increase the surface area available for the edges of adjacent component foam articles to come into contact with each other. Thus, while the thickness of a component foam article may be one measurement, the process of forming the edge, e.g., beveling, results in a beveled surface having a length greater than the thickness of the component foam article, improving the thermal retention properties without substantially changing the component foam article dimensions or the dimensions of the foam structure. Furthermore, skin-forming the webbing to form a skin-formed living hinge enhances the webbing so that it can be folded and unfolded hundreds of times without breaking. Since the skin-forming process described herein can be performed without the need for special equipment, the skin-formed living hinges are highly versatile and low-cost compared to existing foam articles with living hinges.

While reference has been made to edges being “beveled” in some embodiments, it is understood that any suitably shaped edge that permits interfacing component foam articles to form a thermally sufficient seal is contemplated. For example, in other embodiments, edges of component foam articles may have other suitable shapes, which may be used in place of or in addition to a beveled edge.

In some embodiments, the component foam article edges may be formed and shaped by a channel forming process, i.e., the creation of channels results in beveled edges, or rectilinear edges, or some other shaped edge. In some other embodiments, the component foam article edges may be shaped by a process after the channels are formed, i.e., component foam article edges are subsequently formed into beveled edges, or rectilinear edges, or some other shaped edge.

FIG. 2 shows a foam structure 100 including two component foam articles 102 having edges 104 and joined by webbing 106 defined by channel 108 and having a skin-formed portion 118 to form a skin-formed living hinge. Edges 104 have mechanical locking tabs 202 and corresponding mechanical locking slots 204. In some instances, there may be one set of mechanical locking tabs and corresponding slots that run the length of the edge of a component foam article. In other instances, there are multiple sets of discrete tabs and corresponding slots in particular positions along the edge of a component foam article. The edge of a component foam article may have a portion with mechanical locking tabs or slots and a portion without tabs or slots. The edge of one component foam article may have both tabs and slots that correspond to matching slots and tabs on the edge of an adjacent component foam article. The edges of a component foam article may vary in shape, with some edges being beveled and others being rectilinear, but both types of edges may have mechanical locking tabs and slots corresponding to mechanical locking slots and tabs of edges of adjacent component foam articles. In some embodiments, edge features such as the mechanical locking tabs and corresponding slots are formed when the channels are formed, i.e., the same process that forms the channel also forms the mechanical locking tabs and slots. In other embodiments, the edge features are formed by a process after the channels are formed, i.e., component foam article edges are subsequently processed to form edge features.

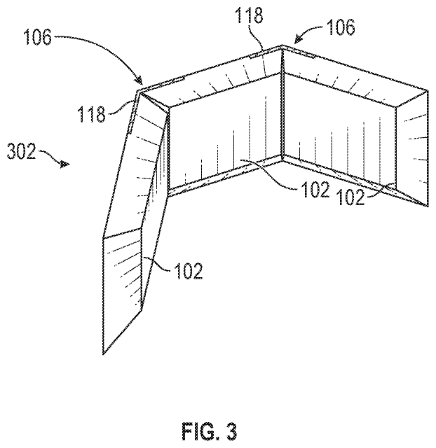

FIG. 3 shows three component foam articles 102 connected by webbing 106 having skin-formed portions 118 to form skin-formed living hinges forming a 3-article system 302 that is configured to be folded into a C-shaped assembly. The three component foam articles are connected in series, with a first component foam article connected to a second component foam article by a skin-formed living hinge and the second component foam article connected to a third component foam article by a skin-formed living hinge. In some embodiments, the 3-article system 302 may be joined to another 3-article system and affixed together using suitable means to form a 6-sided box.

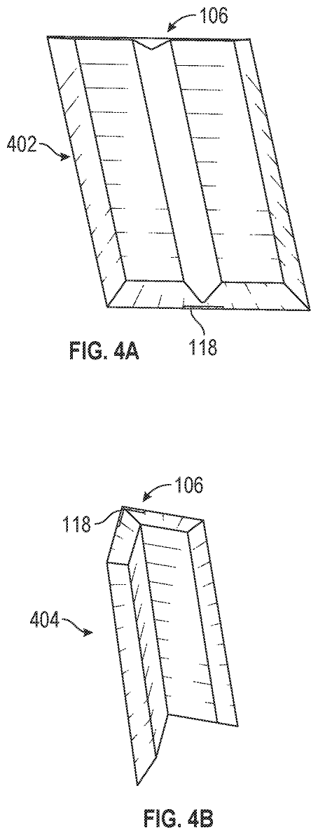

FIG. 4A shows two component foam articles 102 connected by webbing 106 having skin-formed portion 118 to form skin-formed living hinges forming a 2-article system 402 that is configured to be folded into an edge protector. FIG. 4B is a perspective view of a 2-article system 702 that has been folded to form an edge protector 704. In some instances, the two component foam articles have an elongated-rectangular shape, and are connected on the long edge. In other instances, the component foam articles are connected on the short edge. In other instances, the component foam articles are the same size and connected on any edge. In other instances, the component foam articles have different sizes. Any suitable size and shape of the two component foam articles may be used to form the 2-panel system. Upon folding, the resulting edge protector may be used in isolation, or in conjunction with another edge protector, or in conjunction with another foam structure.

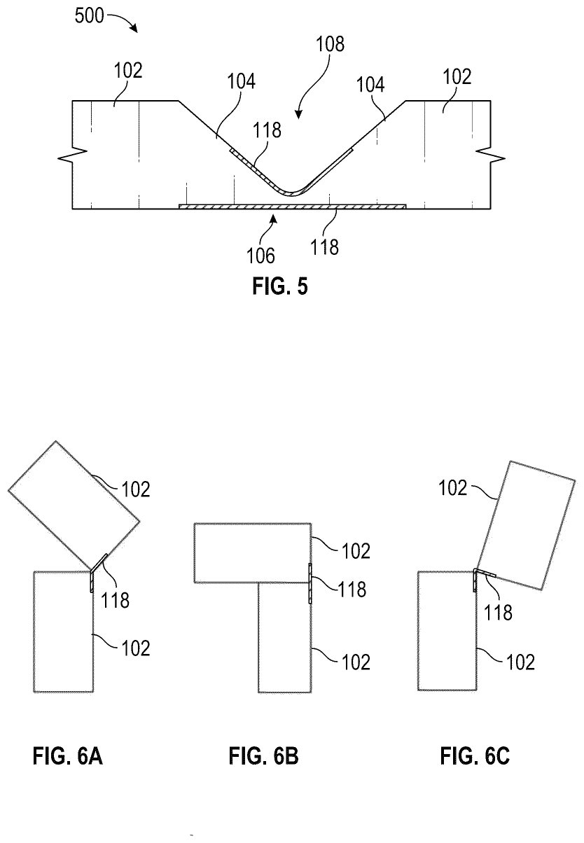

FIG. 5 shows a foam structure 500 including two component foam articles 102 having edges 104 and joined by webbing 106 defined by channel 108 and having a skin-formed portion 118 on an exterior surface of the webbing and a skin-formed portion 118 within channel 108, thereby forming a skin-formed living hinge. In this way, the webbing may be reinforced to a greater degree than a single skin-formed portion. However, the unexpected benefits of forming a skin-formed living hinge are realized with just one skin-formed surface.

FIGS. 6A-6C show two component foam articles 102 connected by a skin-formed living hinge 502 at various rotational angles. The embodiment depicted in FIGS. 6A-6C does not include webbing. It has been unexpectedly discovered that forming a living hinge by joining two otherwise-separate component foam article using a skin-formed portion (i.e., without molding the component foam articles with a webbing) forms a living hinge capable of rotating 270° or more without breaking.

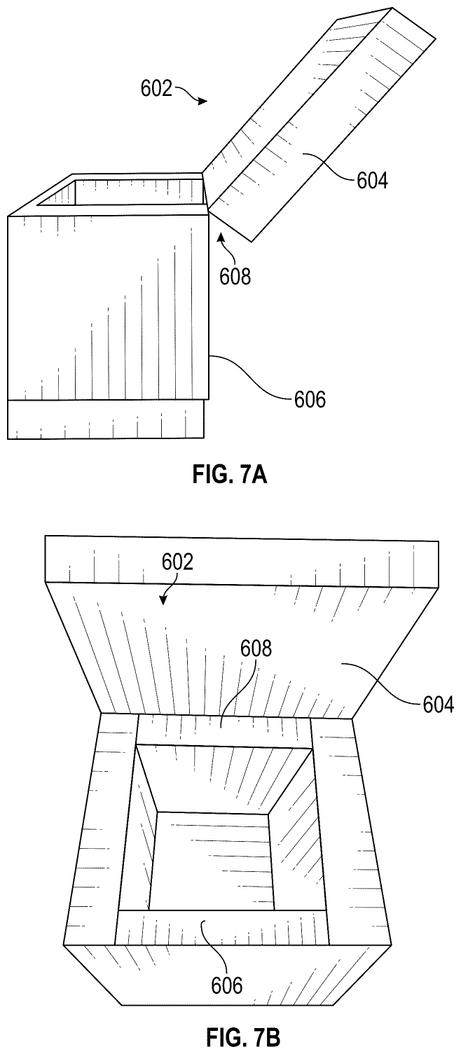

FIGS. 7A-7B show a molded foam article 602 in the form of a box, with a lid 604 secured to the base 606 by a living hinge 608 formed by skin-forming the surfaces of the lid and base that are proximal to one another, thereby joining the lid and base.

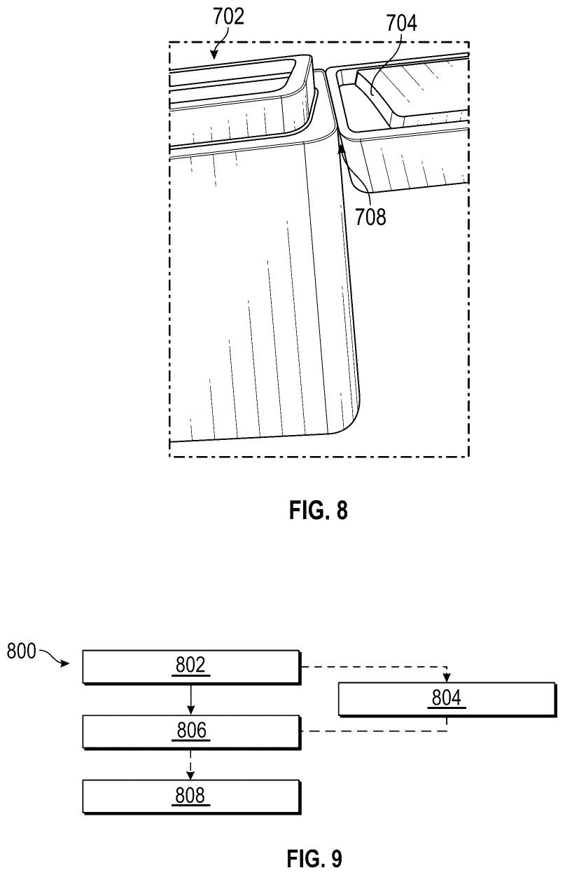

FIG. 8 shows a molded foam article 702 in the form of a box, with a lid 704 secured to the base 706 by a living hinge 708 formed by skin-forming the surfaces of the lid and base that are proximal to one another, thereby joining the lid and base. As depicted in FIG. 8, the skin-formed living hinge of the present disclosure enables a wide range of rotational motion between the joined component foam articles without the need for special equipment.

Methods for Producing Molded Foam Articles Having Living Hinges

Methods for producing molded foam articles having living hinges are also disclosed herein. In one aspect, the methods include producing a molded bead foam article as described above. In another aspect, the method includes molding fusing or molding a plurality of foam beads including polylactic acid to produce a molded foam article, and skin-forming at least a portion of at least one surface of the molded bead foam article to form a skin-formed living hinge.

In some embodiments, known methods are used to produce the molded bead foam articles that used in the presently disclosed methods. For example, U.S. Pat. No. 10,518,444 to Lifoam Industries LLC, discloses methods of producing compostable or biobased foams that are useful for fabricating foamed articles. In the disclosed method, foamed beads formed from a biobased polyester and a blowing agent are molded to form a molded bead foam article. Those method can be used to produce the molded bead foam articles having living hinges of the present disclosure. In another example, U.S. Pat. No. 10,688,698 to Lifoam Industries LLC discloses methods for making molded foam articles, which can be used to produce the molded bead foam articles having living hinges of the present disclosure.

In some embodiments, producing the molded bead foam article involves molding foam particles using standard molding without post-conditioning. Molding molded bead foam articles using standard molding includes the use of a mold having the shape of the final product, including a webbing in embodiments in which a grooved channel is utilized, such that the molded bead foam article has a uniform density and composition across the webbing before skin-forming. In other embodiments, molding producing the molded bead foam articles involves post-conditioning the foam particles in order to form the living hinge. Producing the molded bead foam articles with post-conditioning includes the use of a mold having a gap or space at the location where the living hinge is desired, and then forming the living hinge using a secondary, e.g., separate, skin-forming process. As used herein, “post-conditioning” refers to the application of localized heat and/or localized low pressure in order to change the density, strength, and flexibility of the polymer foam particles, e.g., in a region of the material forming the living hinge.

In some embodiments, the method includes assembling a foam structure out of two or more component foam articles which may be joined using a skin-formed living hinge. In some embodiments, the step of assembling includes folding the component foam articles at the skin-formed living hinge, forming a seal between at least one pair of adjacent edges of the component foam articles for retaining thermal energy at the edges.

In some embodiments, the component foam articles are rigid. In some embodiments, the component foam articles include beveled edges on each of the articles. In certain embodiments, the edges of the component foam articles are molded or machined to form the desired edge geometry.

In some embodiments, the grooved channels defining the webbing in the molded bead foam article have a “V” cross-sectional shape in the open configuration. In other embodiments, the channels may have another shape, such as a rectilinear shape, or curved surfaces, as described herein.

Any suitable method of forming the one or more channels may be used. For example, the channel may be formed simultaneously with the molding of the component foam articles using a mold cavity having the shape of the webbing. In another embodiment, forming the one or more channels may be performed by mechanical milling. In another embodiment, forming the channels is performed by wire cutting. In another embodiment, forming the channels is performed by laser cutting. In another embodiment, forming the channels is performed by water-jet cutting.

In some embodiments, the molded bead foam articles include mechanical locking tabs and corresponding mechanical locking slots on the edges of each of the component foam articles to facilitate a compression fit interlock with adjacent edges of the articles. In some embodiments, the mechanical locking tabs and slots may be on or in surfaces of the beveled edges of component foam articles, wherein those surfaces are interfacing surfaces when a living hinge between the component foam articles is in the closed configuration.

In some embodiments, the molded foam article includes at least two component foam articles joined by webbing. In some embodiments, after forming the webbing as described above, the method includes skin-forming at least a portion of at least one surface of the webbing formed in the molded bead foam article to form a skin-formed living hinge.

In some embodiments, the method includes skin-forming the surface of two adjacent, but otherwise separate (i.e., not connected by webbing) component foam articles, thereby joining the component foam articles by a skin-formed living hinge. It has been unexpectedly discovered that simply positioning two otherwise-separate component foam articles next to each other, and skin forming an upper surface of each, creates a bond between the two component foam articles in the form of a hinge.

In some embodiments, the method is performed in-line. In other words, each step of forming the molded foam article is performed subsequently in approximately the same location. In some embodiments, the method is performed by automated apparatus. In other words, apparatus such as robotic instruments may perform each step necessary for forming the molded foam article, such as deliver the foam particles to the mold, mold the molded foam article, remove the molded foam article from the mold, transport the molded foam article to a skin-forming apparatus, skin-forming a living hinge that is present in the molded foam article and/or joining separate molded foam article using a skin-formed living hinge, fold the molded foam article into a shipper, and the like. It has been unexpectedly discovered that skin-forming the living hinge formed in the molded foam article to form a skin-formed portion increases thermal and mechanical properties over that of shippers containing for example, cotton bats, paper or starch liners, or extruded starch solutions, which are common degradable solutions used instead of conventional EPS.

FIG. 8 is a flowchart depicting a method 800 for making a foam structure. Step 802 includes molding a foam panel blank in a mold from a plurality of polylactic acid-based foam particles. Optional step 804 includes forming one or more grooved channels in the foam panel blank to define a plurality of component foam articles having edges. Optional step 804 produces component foam articles joined by webbing and is suitable for those embodiments in which the webbing is intended to be reinforced by the skin-forming step, such as those embodiments depicted in FIGS. 1A-1D. Step 806 includes skin-forming at least one portion of two adjacent component foam articles to form a skin-formed living hinge. Optional step 808 includes assembling the desired molded foam article by folding the plurality of component foam articles at the skin-formed living hinge(s). In some instances, the method may include steps 802 and 806 but omit steps 804 and 808. For example, steps 802 and 806 may be performed to form a skin-formed living hinge without first forming webbing, as illustrated in the embodiment depicted in FIGS. 6A-6C.

As described above, the skin-forming process of step 806 may be performed using inexpensive equipment, on the order of hundreds of dollars or less. In contrast, conventional living hinge molding techniques require highly specialized equipment costing thou sands or tens of thousands of dollars. Furthermore, the skin-forming may be performed in less than 10 seconds, such as between 2-5 seconds. Since the skin-forming process can be performed on the surface of an otherwise-unremarkable molded foam article, i.e., one that has not been specially made for skin-forming or for forming a living hinge, the skin-formed living hinge requires less material. In contrast, conventional living hinge molding techniques require additional foam beads so that the living hinge is sufficiently dense to resist breakage after multiple folding and unfolding cycles. The skin-forming process can be performed at any point during or after producing the molded foam article, significantly increasing the versatility of the process. Finally, any molded foam article as described herein can be joined to any other by a skin-formed living hinge; no grooved channel is necessary to enable the hinge, although the skin-forming process significantly enhances those living hinges initially formed as a grooved channel.

The skin-forming process can be performed within a mold during or after formation of the component foam articles by incorporating a heating strip attached to the mold at the location opposite to that of the groove (108 in FIG. 1). The heating strip cycles in temperature between 200 F to 330 F during the molding cycle allowing 5 s of duration at the 330 F temperature. This process eliminates moving parts such as core pull or anvils. Alternatively, the heat strip can be on both sides of the mold resulting in article described in FIG. 5. The temperature setting depends on material of construction of heating strip, mold wall thickness, part thickness, and cycle time of process.

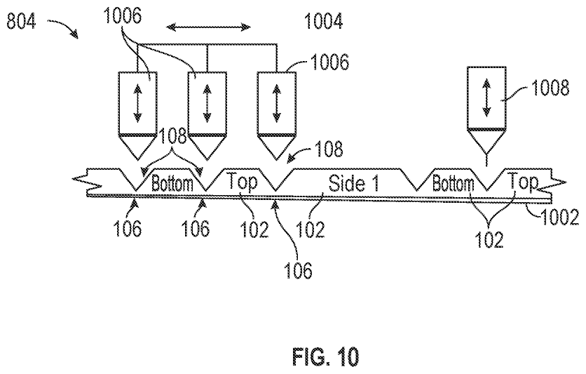

FIG. 10 is an alternate illustration of optional step 804, in which a molded foam article including component foam articles 102 moves over a conveyor 1002. An array 1004 of heated forming heads 1006 is aligned over the molded foam article. The array 1004 is lowered onto the molded foam article and the heated forming heads collapse the polymer foam particles to form the channels and living hinges. The molded foam article would subsequently be passed to an apparatus for skin-forming the living hinges. Cutoff head 1008 is subsequently lowered through one of the one or more channels to fully separate one component foam article from the next component foam article (e.g., to separate one foam structure from the next foam structure), resulting in foam structure 100.

### Examples

The disclosure may be further understood with reference to the following non-limiting examples.

### Example 1: Skin-Formed Living Hinge without Channel

Two flat pieces of molded PLA bead foam were held together and exposed to a heated platen at 330° F. for about 5 seconds. This resulted in formation of a skin on the surfaces of both pieces of molded PLA and surprisingly resulted in a continuous film spanning both pieces. The result of skin-forming is slight densification of the outermost beads that are exposed to the heated platen. Scraping and measuring density of the outermost beads showed a density increase by factor of 4. The next layer of beads were still at a density of 1.5 pcf, corresponding to the original molded PLA density. The resulting article could be articulated “open” and “closed,” without breaking. FIGS. 6A-6C schematically depict the resulting joined articles.

### Example 2: Mechanical Properties and Robustness of Skin-Formed Living Hinge

Living hinges were formed as described in Example 1 under three different process conditions: Prepared at 310F with 2 seconds of heat and 5 psi of force (Sample A); Prepared at 330F and 3 seconds of heat and 5 psi of force (Sample B); and Prepared at 370F and 5 seconds of heat and 10 psi of force (Sample C). Each sample was evaluated for durability, tensile strength, and failure mode.

Three sets of conditions were explored to produce hinge. First, each of the hinges were articulated for a 100 cycles between fully closed (i.e., 0 degrees) to 120 degrees. None of the three hinges displayed any changes in the skin-formed living hinge. Upon completing this study, the hinges were flexed to 270 degrees, an extreme that would be uncommon under normal conditions. Each of hinges survived without failure or visual change in skin.

A second test was performed quantify the differences in properties and determine ranges of potential operating conditions. This test took the form of 3-point bend tests. Each foam panel was a 2.5″×2.5″×1.25″ cube. When combined with a skin-formed living hinge, the joined piece was 5″×2.5″×1.25″. The joined panels were placed on a flex tester such that the cross bar applied force directly in the center, opposite of the durable skin's hinge point. In other words, this test applied force in a way seeking to reduce the rotational angle below 0 degrees. This method effectively tested the skin's resistance to tensile forces pulling it apart.

$$Tensile Strength = \frac{Force}{Cross - sectional Area}$$

The forces at which samples broke or testing concluded were recorded with a force transducer. The cross-sectional area at which tensile force was being applied was the 5″ length of the combined foam panels along with the thickness of the skin-formed living hinge. The thickness of the skin-formed living hinge was challenging to measure as it was part of the foam itself; some portion of the surface beads and, potentially, the beads underneath were affected by the skin-forming process. For this calculation, the skin thickness was estimated at 0.10″ for
Sample A, 0.15″ for Sample B and 0.020″ for Sample C.
Sample A: Required 60N of force before the skin broke. Calculated tensile strength was approximately 270 psi.
Sample B: Required 100N of force before the skin broke. Calculated tensile strength was approximately 300p si.
Sample C: Required 250N of force, but the skin did not break. Estimated tensile strength was approximately 450 psi

Surprisingly, failure of the skin-formed living hinge manifested in the area of the skin-formed portion spanning the component foam pieces, rather than the midpoint joining the two pieces.

### Example 3: Thermal Shipper with Hinged Opening

Two shippers was formed as described herein from polylactic acid-based foam beads. The shippers are depicted schematically in FIGS. 6A, 6B, and 7. Each shipper included a foam lid joined to the base by a skin-formed living hinge. The lid was capable of articulating fully open and fully closed over 100 times without noticeable reduction in performance or visual degradation.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A molded bead foam article comprising at least two component foam articles formed from polylactic acid, wherein a first surface of a first component foam article is proximal to a second surface of a second component foam article, and wherein the first surface and second surface have been skin-formed.

2. The molded bead foam article of claim 1, wherein the skin-formed first surface and skin-formed second surface comprise a layer of skin-formed beads having a thickness between about 5 mil and 30 mil.

3. The molded bead foam article of claim 1, wherein the skin-formed first surface and skin-formed second surface are joined together as a result of the skin-forming to form a skin-formed living hinge.

4. The molded bead foam article of claim 3, wherein the skin-formed living hinge is configured to rotate by up to around 270° without breaking.

5. The molded bead foam article of claim 1, wherein the first surface is joined to the second surface by webbing such that the skin-formed first surface and the skin-formed second surface are configured to reinforce the webbing.

6. The molded bead foam article of claim 5, further comprising a skin-formed surface on an inner surface of the webbing opposite to the first surface and second surface.

7. The molded bead foam article of claim 3, wherein the webbing has a thickness equal to from one to seven polymer foam particles.

8. The molded bead foam article of claim 3, wherein the molded living hinge is defined between interfacing edges of the at least two component foam articles and the interfacing edges are beveled.

9. The molded bead foam article of claim 3, wherein the at least two component foam articles further comprise one or more edge features for facilitating interlock and alignment of the at least two component foam articles when the skin-formed living hinge is in the closed configuration.

10. The molded bead foam article of claim 1, wherein:
the at least two component foam articles comprise two component foam articles connected to each other by a skin-formed living hinge forming a 2-panel system, and
the 2-panel system is foldable to form an edge protector.

11. The molded bead foam article of claim 1, wherein the molded bead foam article is in the form of a box having a plurality of sides.

13. A method for producing a molded bead foam article comprising:
molding a plurality of foam beads comprising polylactic acid in a mold to produce two or more component foam articles, and
skin-forming a first surface of a first component foam article and a second surface of a second component foam article.

14. The method of claim 13, wherein the skin-formed first surface and skin-formed second surface are skin-formed while the molded bead foam article is in the mold.

15. The method of claim 14, wherein a heat strip is present within the mold and skin-forms the first surface and the second surface while the molded bead foam article is in the mold.

16. The method of claim 13, wherein the skin-formed first surface and skin-formed second surface are skin-formed after the molded bead foam article has been removed from the mold.

17. The method of claim 16, wherein the skin-forming step is performed using a heated roller, a heated platen, or a combination thereof.

18. The method of claim 13, wherein the skin-forming step is performed in less than 10 seconds.

19. The method of claim 13, wherein the skin-formed first surface and skin-formed second surface are joined together as a result of the skin-forming to form a skin-formed living hinge.

20. The method of claim 13, wherein the first surface is joined to the second surface by webbing.

21. The method of claim 20, wherein skin-forming the first surface and skin-forming the second surface is configured to reinforce the webbing.
